(19) United States
(12) Patent Application Publication
(10) Pub. No.: US 2008/0168799 A1
(43) Pub. Date: Jul. 17, 2008

(54) Tension ring

(76) Inventor: Kenneth D. Fogel, Millburn, NJ (US)

Correspondence Address: B2 PATENT SERVICES, 406 ROSEMONT-RINGOES ROAD, STOCKTON, NJ, 08559, US

(21) Appl. No.: 11/653,609

(22) Filed: Jan. 16, 2007

(51) Int. Cl. A44C 9/00; B23P 13/00

(52) U.S. Cl. 63/15; 29/8

(57) ABSTRACT

This invention relates to a tension ring capable of mounting a diamond or other gemstone by applying sufficient pressure to the girdle of the stone. The tension ring of this invention provides enough springiness and elasticity to maintain the pressure at the girdle of the stone under normal wear conditions, such as a snag or blow to the ring. The key aspect to the disclosed tension ring is the fusion of a cast component which provides the detail and polish with a cold worked component which provides springiness and elasticity to the ring. The benefit to a tension mount is that more incident light can strike the gemstone and enhance the natural brilliance and luster beyond other types of settings.

The present invention relates to a tension ring and mount for holding a diamond or other stone in place simply by the spring action of the ring itself. Tension rings are desirable in that they provide the jeweler the ability to set the stone into the tension ring, such as an engagement type ring, quickly and without the need to customize the mount for each style of gem. Additionally, the tension mount gives the ring a unique and distinctive look compared to traditional gem mounts.

### BACKGROUND

There are two methods for producing jewelry and other fine metal works, such as dental implants. These are the casting and cold-working (wrought) processes. Casting allows the producer the ability to create intricate patterns and designs as well as high gloss. Cold-worked articles can have higher elasticity, resiliency and springiness but do not afford the high level of detail often required in the manufacture of jewelry.

One particularly demanding application is the production of a tension ring. A tension ring is a combination of ring and mount for a diamond or gemstone in which the stone is held in place between two sections of the ring by spring action (FIG. 1). The spring tension applied by the ring is sufficient to hold the gemstone in place while providing a novel and unique appearance. A jeweler can easily place a stone in the setting by opening the spring action of the ring with a tool so designed and placing the stone into the ring. Once the spring action of the ring is allowed to return to its original position, the gemstone is firmly held in place.

Typical cast rings do not allow for sufficient springiness to hold the gemstone within the ring with enough force to secure the gemstone in the event of a snag or blow to the ring. There still exists the need for a tension ring in which high enough force is applied to the gemstone to hold it in place, yet with the ability to produce very fine detail and highly polished surfaces.

### BRIEF DESCRIPTION OF THE DRAWINGS

FIG. 1 shows a tension ring in which a cold worked component (1) is inset into the cast component (2) and the setting posts (3) that will ultimately hold the gemstone's girdle in position.

FIG. 2 shows the cast component (2) being compressed in a mandrel (4) in which the downward force on the shoulders (5) of the cast portion act to completely compress (close) setting posts (3).

FIG. 3 shows the cast component (2) with the shoulders (5) for compression in the mandrel (4).

FIG. 4 shows the cast component (2) before the cold worked component (1) is inserted into the receiving slots (6).

FIG. 5 shows the two types of cold worked components. Cold worked components (1) are meant to be inlayed into each the exterior slots (6) and cold worked component (7) would be inlayed into an interior slot (not shown).

### DETAILED DESCRIPTION OF THE INVENTION

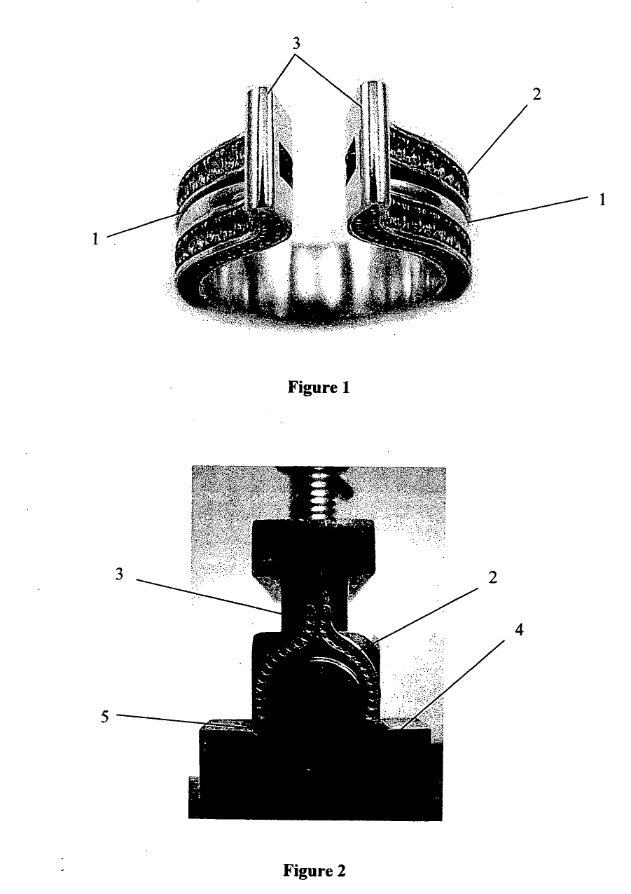

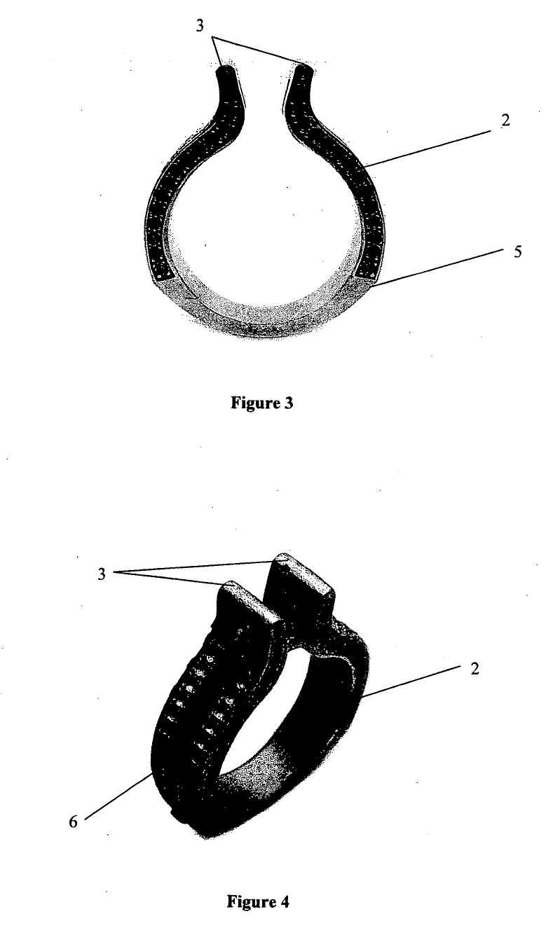

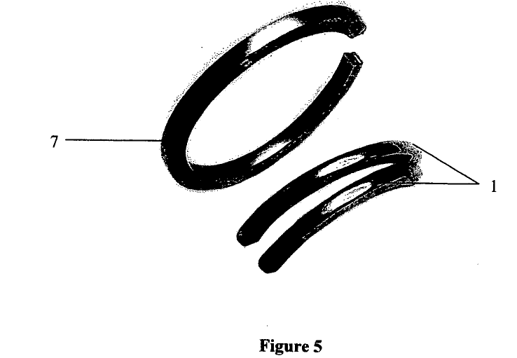

A tension ring is defined as a ring capable of holding a gemstone by applying sufficient force at the girdle of the stone to hold it in place under normal wear conditions. Girdle is defined for purposed of this invention to be the largest horizontal periphery. No other means for holding the stone is used in this type of mount. An example of a tension ring is shown in FIG. 1.

A solution to the problem of creating sufficient springiness from a cast article to produce a tension ring has been found by implanting a highly cold worked component (stress bearing) to the cast component to add stiffness, springiness, hardness and wear resistance. The stress bearing component must be securely and permanently attached to the cast component in order to achieve the desired results. In one embodiment of this invention this can be accomplished by cold welding by compression. In another embodiment the ends and or edges of the cold worked component (1) can be laser welded to the slot (6) of the cast component. One of skill in the art would recognize that great care must be taken during the welding step in order to minimize general heating of the ring and thus reducing the overall hardness/springiness.

The receiving slot in the cast component may be on the outer surface of the ring (FIG. 4) or on the inner surface of the cast component. In the case of the slots being on the outer surface, the cold worked component will comprise two semi-circular pieces (1). In the embodiment where the cold worked component is placed in a slot in the inner surface of the ring, a single piece (7) will be attached.

In order to obtain the proper conformation of the girdle, the ring must be fully compressed before the cold work components are attached. This can be done by compressing the cast component against a mandrel (FIG. 2) while the cold worked components are fashioned in place.

Springiness is directly related to the hardness of the metal in question and is drastically influenced by the way the metal is worked. While the tension on the stone need not be great, it must be applied as a constant force, even in the event of a snag or blow to any portion of the ring. For example, when cast, an alloy of 51 percent platinum and 49 percent palladium provides a hardness of roughly 666 MPa (86 HV), while hardnesses of up to 1667 MPa (170 HV) can be obtained from the same alloy in the heavily cold worked state. In one embodiment of this invention a hardness of the cold worked component of greater than 981 MPa (100 HV) will provide sufficient springiness for a tension ring application. In another embodiment a hardness of the cold worked component of greater than 1373 MPa (140 HV) will provide acceptable properties.

The choice of alloys will be very much related to the design and preferences of the wearer as well as the jeweler. One skilled in the art would recognize that a variety of metal alloys have been used to prepare jewelry, all of which can be utilized with the present invention. In one embodiment of this invention the alloy will be chosen from the group containing 14 karat yellow gold, 14 karat white gold or platinum containing alloys. Of particular utility in these applications is the platinum alloy, containing 51 percent platinum and 49 percent palladium as described in U.S. patent application Ser. No. 11/221,308 incorporated herein by reference.

One skilled in the art would recognize that different alloys can be used to prepare the cold worked and cast components as long as they can be securely fused by welding or compression. In one embodiment of this invention, the same alloy will be used to prepare both the cast and cold worked components of the ring. In another embodiment the cast and cold worked components are of different alloys.

One skilled in the art would recognize that a tension mount of the type described in this invention would allow for more incident light to contact the gem, providing more sparkle and brilliance in a diamond. Other applications of this technology are possible such as the production of bracelets or springy necklaces. Another application would be a gemstone mount for earrings which would give the maximum exposed surface area of the diamond while securely holding the stone in place.

### EXPERIMENTAL

### Vickers Hardness Test

The Vickers hardness test method consists of indenting the test material with a diamond indenter, in the form of a right pyramid with a square base and an angle of 136 degrees between opposite faces subjected to a load of 1 to 100 kg. The full load is normally applied for 10 to 15 seconds. The two diagonals of the indentation left in the surface of the material after removal of the load are measured using a microscope and their average calculated. The area of the sloping surface of the indentation is calculated. The Vickers hardness is the quotient obtained by dividing the kgf load by the square mm area of indentation.

### F=Load in kg

d=Arithmetic mean of the two diagonals, d1 and d2 in mm
HV=Vickers hardness

$$HV = \frac{2 F sin \frac{136 °}{2}}{{d}^{2}}$$

$$HV = 1.854 \frac{F}{{d}^{2}}$$

To convert HV to MPa multiply by 9.807

What is claimed:

1) A tension ring comprising a cold worked component and a cast component.

2) The tension ring of claim 1 wherein the cold worked component has a hardness of greater than 981 MPa.

3) The tension ring of claim 1 wherein the cold worked component has a hardness of greater than 1373 MPa.

4) The tension ring of claim 1 wherein the cast component is made of an alloy from the group consisting of 14K white gold, 14K yellow gold and 51 percent platinum/49 percent palladium.

5) The tension ring of claim 4 wherein the cold worked component is made of an alloy from the group consisting of 14K white gold, 14K yellow gold and 51 percent platinum/49 percent palladium.

6) The alloy of claim 4 wherein the alloy consists of 51 percent platinum and 49 percent palladium.

7) The alloy of claim 5 wherein the alloy consists of 51 percent platinum and 49 percent palladium.

8) The tension ring of claim 1 wherein the cast component and the cold worked component are fused together by laser welding or cold compression welding.

9) A process for making a tension ring comprising the steps of, compressing a cast component of a ring around a mandrel and attaching a cold worked component to the cast portion by laser welding or cold compression welding.
